(19) United States
(12) Patent Application Publication
(10) Pub. No.: US 2006/0236601 A1
(43) Pub. Date: Oct. 26, 2006

(54) Playground border with integrated drain

(76) Inventor: Jeff Barber, Emmitsburg, MD (US)

Correspondence Address: Paul W. Koda;Koda Law Firm, 4 Baederwood Court, Rockville, MD, 20855, US

(21) Appl. No.: 11/113,273

(22) Filed: Apr. 25, 2005

(51) Int. Cl. A01G 1/00; E02D 27/00

(52) U.S. Cl. 47/33; 52/102

(57) ABSTRACT

The present invention is a playground or landscaping border assembled from prefabricated component parts, each manufactured from a combination of shredded rubber bonded with an elastic adhesive urethane compound to form a porous and flexible structure for use in a playground or landscaping environment. The structure is integrated with a rigid plastic pipe having annular spaces along its side in order to serve as a drain.

### SUMMARY OF THE INVENTION

The construction of modern playground equipment focuses not only on a child's physical fitness but their safety while using the equipment. There have been numerous safety advances as more attention has been paid to preventing injury on the playground. For example, flexible plastic parts are used more often to provide increased deflection upon impact, which reduces the chance of a broken bone. Equipment is now anchored more securely in order to prevent injuries that might occur if a structure shifts position in an unintended way. And, new playground surfaces have been developed that provide improved cushioning in the event of a fall.

At the same time, more attention has been given to improved construction techniques and construction site preparation. Site selection is often integrated with the design of an entire neighborhood or building. Improved foundation and anchoring methods are routinely employed. In addition, building construction quality grading and drainage systems are incorporated into the overall design of modern playgrounds. The present invention provides an improved containment system for playground safety surfacing while integrating a cost-effective method for draining storm water, improving the overall safety of the playground site, and reducing future playground maintenance.

In particular, the present invention is a new and improved cushioned playground border structure that incorporates a rigid plastic drain to provide site drainage. The exterior structure layer is manufactured from a combination of shredded rubber bonded with an elastic adhesive urethane compound to form a porous cushion. This exterior layer is bonded to an interior plastic pipe having annular drain holes for channeling storm water. The playground border structure is anchored around a playground perimeter and serves to drain water from its surface. A distinct advantage of the water drainage portion of the present invention is that it is installed at the existing grade of the playground perimeter, which means that a drainage system does not have to be constructed below ground level. This, in turn, reduces the overall cost of constructing the playground.

In addition, the playground border structure of the present invention provides improved safety features over existing playground borders currently in use. Typically, playground borders are constructed of railroad ties anchored using steel rebar. This arrangement is unsafe in several respects. First, the wooden ties offer little cushioning, which means that when a child falls against it, they are more likely to sustain an injury. Also, the fact that the structure is made of wood and exposed to the elements of weather means that the wood is more prone to splintering which, in turn, is an additional safety hazard. Finally, while the presence of steel rebar protruding from the ground serves as an anchor point, it is also a particularly dangerous structure to have exposed in a playground environment. There have been improvements to the standard railroad tie playground border including replacement structures that offer more cushioning without the chance for developing splinters. However, these modifications continue to incorporate steel rebar, which protrudes from the ground. The present invention eliminates the need for using steel rebar by integrating a fastening tab within the border structure that is only exposed and anchored at or below ground level. As a result, the present invention eliminates the previous requirement for constructing playground borders with still pins that may become exposed over time.

As may be seen by the preferred embodiment described below, the present invention is an improvement over existing playground borders. The present playground border invention incorporates a drainage system that eliminates the need for a separate below grade level drain. At the same time, this invention improves the overall safety of the playground perimeter by not only providing a cushioned structure, but also by eliminating the need for including exposed steel rebar along the perimeter of the playground.

Finally, it should be understood that this invention applies to planters, gardens, drainage areas, exterior walls and foundations, or other similar building and landscaping structures as well as to playgrounds.

### PREFERRED EMBODIMENT OF THE INVENTION

As may be seen in the disclosed drawings, the present invention is a border structure 100 positioned around the perimeter of a playground 200. Border structure 100 is comprised of a variable number of border components 102, 103, and 104, which are connected to each other and arranged in a manner to form the perimeter of a closed space 101. FIGS. 3 and 4 show top views of two exemplary border structures having differing shapes. Border structures similar to that shown in border structure 100 may also incorporate border components 210, 211, 212, 213, 214, 215, 216, 217, 218, and 219. The resulting structures may either serve to completely enclose a playground space or merely to serve as the edge of a playground surface. Assembled border components are specifically not restricted to providing perimeters or edges to playgrounds, but may be used for planters, gardens, drainage areas, exterior walls and foundations, or other similar building and landscaping structures.

Border components 102, 103, 104 and 210 though 219 are constructed in a similar manner of similar materials. Their differences exist only because of the relative positions they occupy within a selected border or edge structure. In particular, border component 102 is a straight section. Border components, 103 and 104, are complimentary right angle components. Border components 210 and 211 also are complimentary right angle components utilizing a curved rather than right angle pipe structure. Border components 212 and 213 incorporate complimentary 45 degree angle pipe structures, while border components 214 and 215 incorporate complimentary 22.5 degree angle pipe structures. Border components 216 and 217 illustrate the incorporation of complimentary 45 degree angle ‘Y’ style pipe structures, while border components 218 and 219 show complimentary ‘T’ style pipe structures. For ease in understanding the configuration of border structure 100, the right angle border components will be referred to as exterior right angle border component 103 and interior right angle border component 104.

As shown in FIG. 5, border component 102 comprises drain pipe 110, support structure 111, strap 112, and rivet 113. In a preferred embodiment, drainpipe 110 is manufactured from poly-vinyl chloride (PVC) plastic pipe. Other suitable plastic, hard rubber, or related compounds may be used for drain pipe 110, so long as the material is rigid rather than flexible. Drain pipe 110 has a series of annular spaces 114 along its length. In a preferred embodiment, annular spaces 110 are circular in shape, having a diameter no larger than ¾ inch, and distributed along the upper-half of drain pipe 110 at a distance no closer than 3 inches. Other embodiments may incorporate annular spaces distributed over the entire surface of drain pipe 110. In addition, other embodiments may incorporate annular spaces of differing shapes and diameters.

Drain pipe 110 is fitted with a female end 115 and male end 116, which allows for adjacent drain pipes to be fitted to either end of border component 102. The corresponding fittings are made using the standard male to female connections. In this way, depending upon the application, various combinations of border components 102, 103, 104 and 210 though 219 may be assembled to create a wide range of border and edge shapes. In preferred embodiments, male to female connections are secured with PVC glue or similar adhesive compound.

Support structure 111 is the visible component of the playground or landscaping perimeter that allows for cushioned safety during physical contact by a child or other person. Support structure 111 is constructed of shredded rubber of a variety of colors bonded with an elastic adhesive urethane compound. The preferred embodiment for the shredded rubber is of the same quality used for automotive tires and cut to a size no larger than 1 inch in any dimension. The elastic adhesive urethane compound is any of a number of commercial grade bonding agents. Support structure 111 is made of the composite formed by mixing the shredded rubber with the elastic adhesive urethane compound between approximately a 10:1 and 5:1 weight ratio, with a preferred weight ratio of 7.5:1. The resulting cured composite forms a flexible porous material suitable for allowing storm water to pass through. Residual elastic adhesive urethane compound contained within support structure 111 is used to adhere support structure 111 to drain pipe 110.

Support structure 111 is geometrically formed around drain pipe 110 so that the bottom plane 117 of support structure 111 is tangential to the lower wall of drain pipe 110. In addition, support structure 111 is formed around the female end of drain pipe 110 so that both the end of support structure 111 and the female end of drain pipe 110 are flush with each other. At the same time, support structure 111 is formed around the male end of drain pipe 110 so that the male end of drain pipe 110 extends from the end of support structure 111. In a preferred embodiment, this extension is between one (1) and two (2) inches in length. This extension allows the drain pipes 110 of border components 102, 103, 104 and 210 though 219 to be interlocked while still having the corresponding support structures 111 remain in physical communication with each other.

In one embodiment, strap 112 is wrapped around drain pipe 110 and fitted in place by friction and secured by rivet 113. Other embodiments may omit rivet 113 and use other means for securing strap 112 to itself. In one embodiment, strap 112 is secured to itself using a plastic staple. In another embodiment, strap 112 is secured to itself using a heat bond. And, in another embodiment, strap 112 is secured to itself using a plastic locking tooth mechanism. Strap 112 is perpendicular to drain pipe 110 and extends parallel to and in the same plane as the bottom plane 117 of support structure 111. Strap 112 extends past edge 118 of support structure 111 where strap 112 includes an annular space for the placement of an anchor bolt. Each border component 102, 103, 104 and 210 though 219 is fitted with at least two (2) straps 112.

Border components 102, 103, 104 and 210 though 219 are fitted together by connecting corresponding drain pipes 110 in order to form a closed perimeter. Each border component 102, 103, 104 and 210 though 219 is placed on any surface and anchored with pins through straps 112. The entire perimeter or edge configuration of interconnected border components 102, 103, 104 and 210 though 219 are arranged on a grade between 1% and 2% to allow water to flow by gravity through drain pipes 110. There may be one (1), two (2), or more high points on the perimeter from which begins its descent through the connecting drain pipes.

### DESCRIPTION OF DRAWINGS

FIG. 1 is a perspective view of a closed playground or landscaping perimeter.

FIG. 2 is a partially exploded view of a closed playground or landscaping perimeter.

FIG. 3 is a top view of a closed perimeter.

FIG. 4 is a top view of a closed perimeter.

FIG. 5 is perspective view of a border component showing the exterior cushioning layer, internal drain pipe, and securing straps.

FIG. 6 is perspective view of a strap with corresponding rivet.

FIG. 7 is a top view of a right angle border component (103).

FIG. 8 is a top view of a right angle border component (104).

FIG. 9 is a top view of a curved right angle border component (210).

FIG. 10 is a top view of a curved right angle border component (211).

FIG. 11 is a top view of a curved 45 degree angle border component (212).

FIG. 12 is a top view of a curved 45 degree angle border component (213).

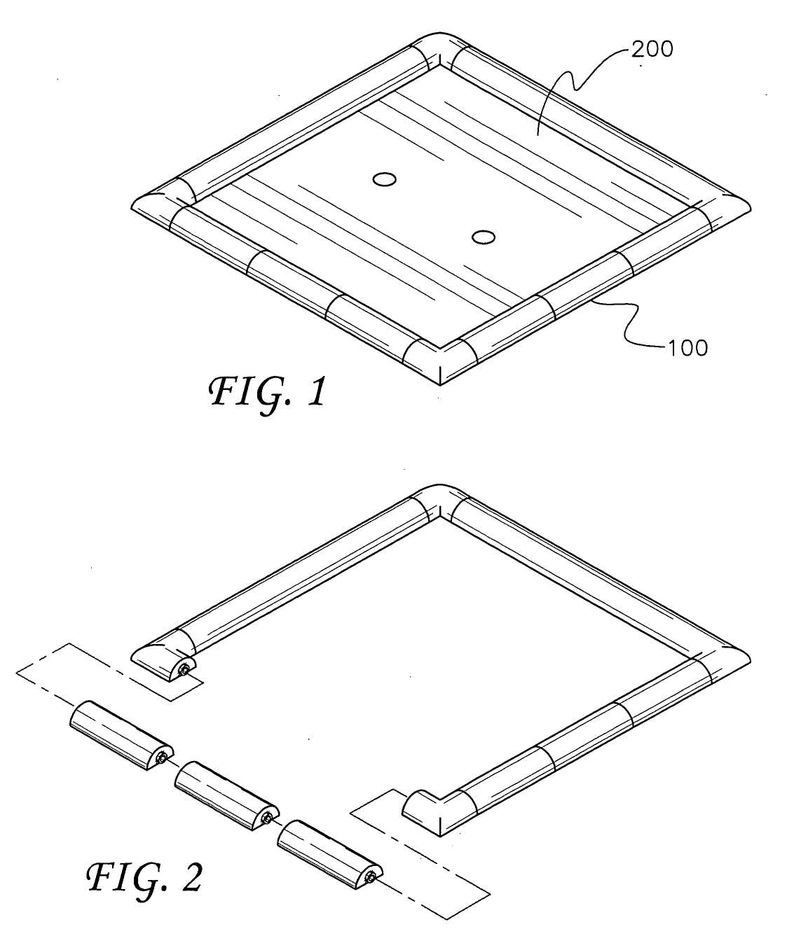

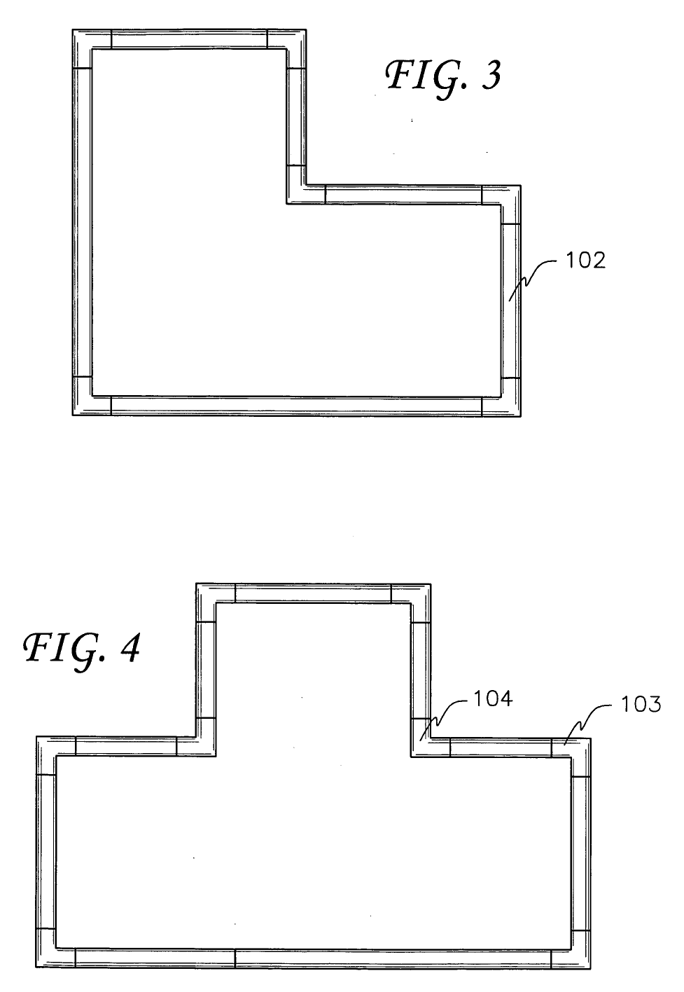

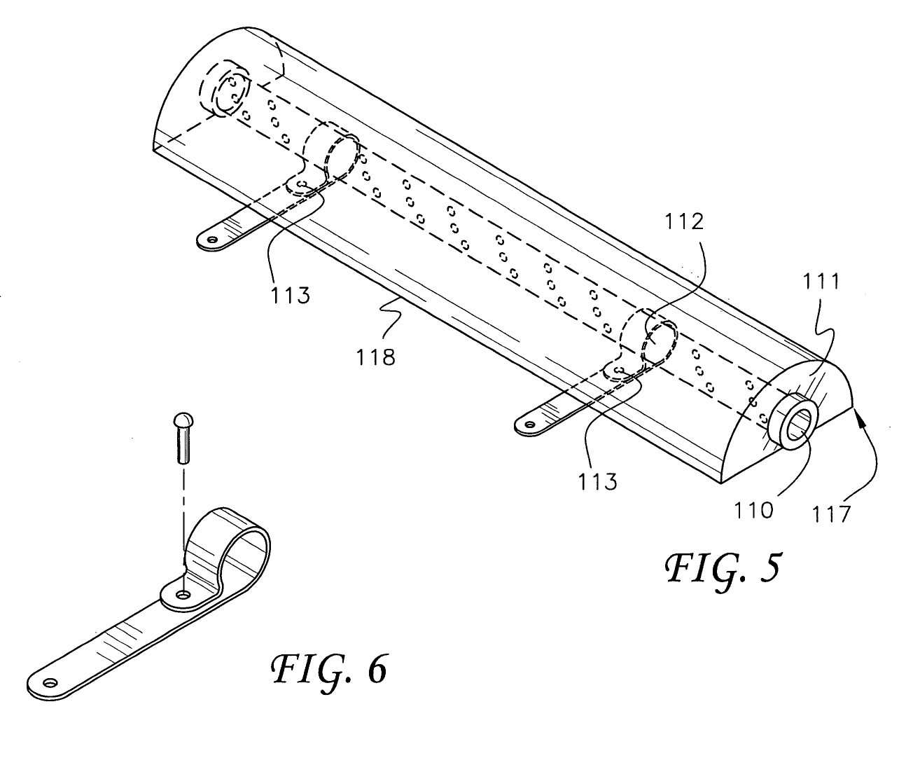

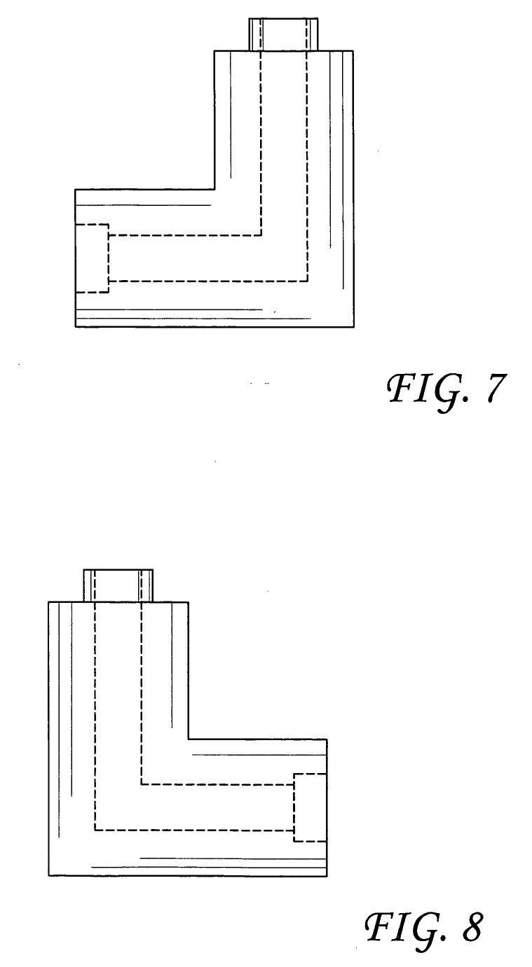

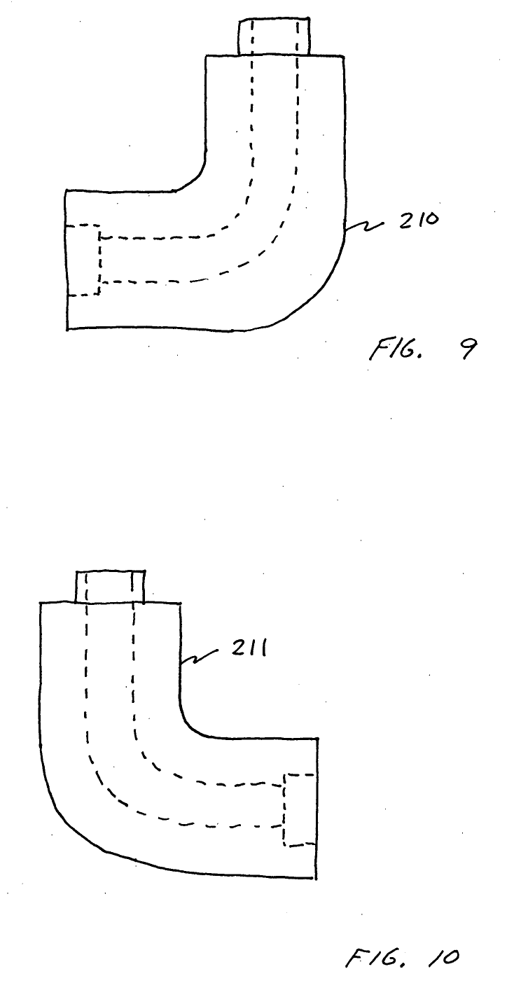

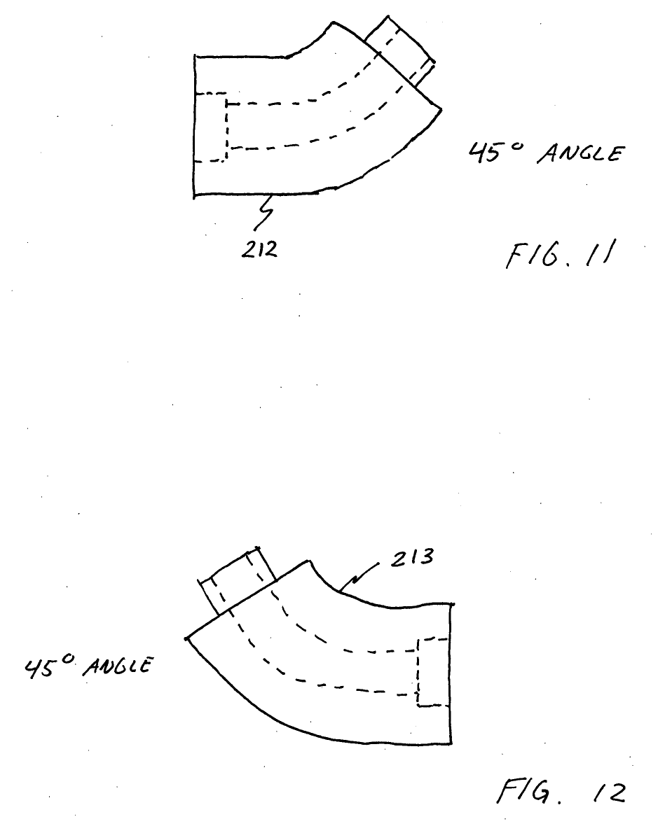

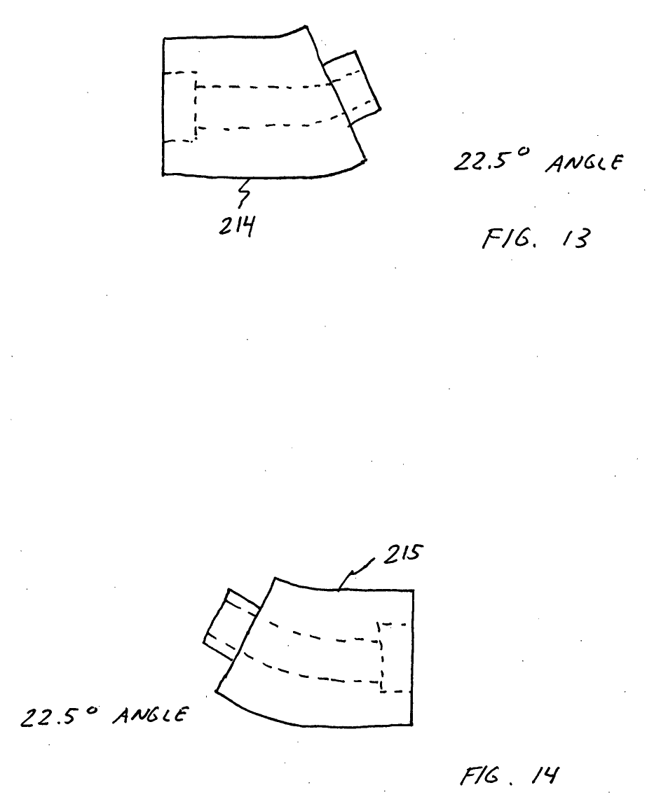

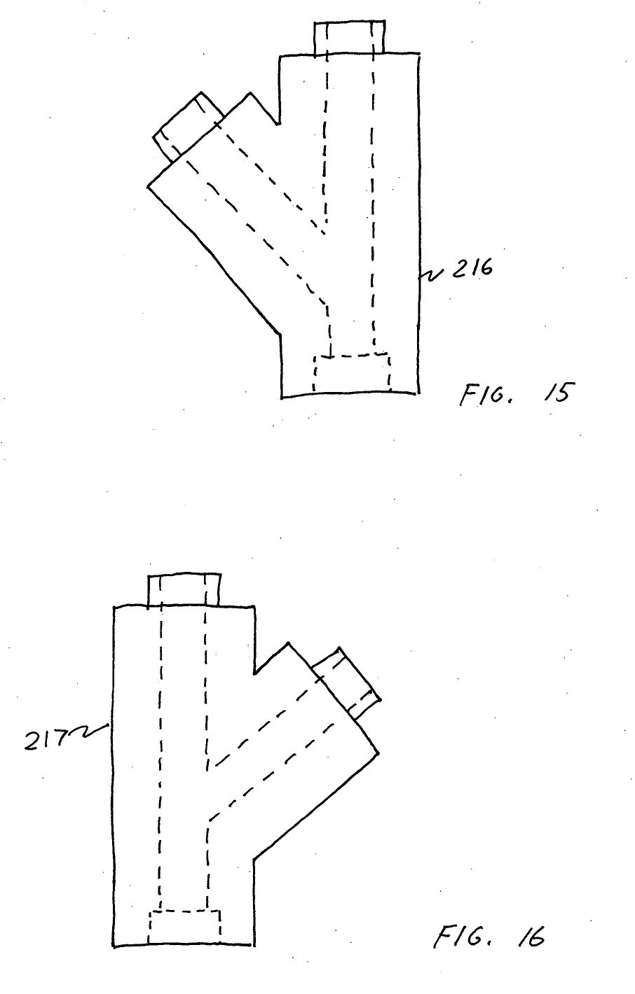

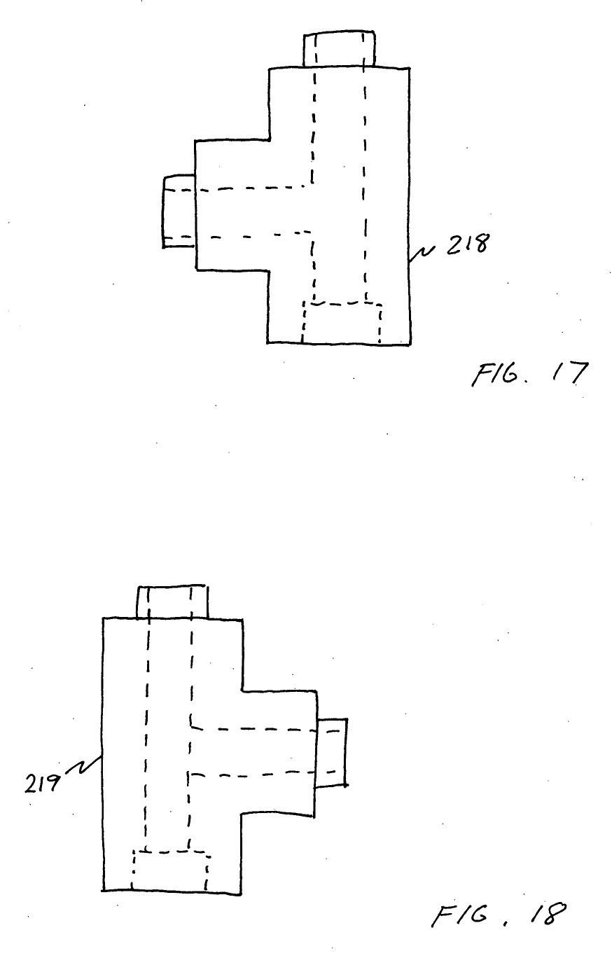

What is claimed is:

1. A border comprising:
a variable number series of interlocking component structures; and
said component structure having a drain pipe with a cushioning exterior layer.

2. The border according to claim 1, wherein said drain pipe has annular spaces distributed along its exterior surface.

3. The border according to claim 2, wherein said cushioning exterior layer is constructed of shredded rubber bonded with elastic adhesive urethane to form a porous compound.

4. The border according to claim 3, wherein said drain pipe has a male fitting at a first end of said drain pipe and a female fitting at second end of said drain pipe.

5. The border according to claim 4, wherein said drain pipe is constructed of PVC plastic.

6. The border according to claim 5, wherein said annular spaces are circular in shape.

7. The border according to claim 6, wherein said annular spaces are approximately three (3) inches apart.

8. A border comprising:
a variable number series of interlocking component structures forming a closed perimeter; and
said component structure having a drain pipe with a cushioning exterior layer.

9. The border according to claim 8, wherein said drain pipe has annular spaces distributed along its exterior surface.

10. The border according to claim 9, wherein said cushioning exterior layer is constructed of shredded rubber bonded with elastic adhesive urethane to form a porous compound.

11. The border according to claim 10, wherein said drain pipe has a male fitting at a first end of said drain pipe and a female fitting at second end of said drain pipe.

12. The border according to claim 11, wherein said drain pipe is constructed of PVC plastic.

13. The border according to claim 12, wherein said annular spaces are circular in shape.

14. The border according to claim 13, wherein said annular spaces are approximately three (3) inches apart.

15. A border component comprising:
a drain pipe;
at least one anchor strap in communication with the exterior surface of said drain pipe; and
and a cushioning exterior layer bonded to said drain pipe and said anchor strap.

16. The border component according to claim 15, wherein said drain pipe has annular spaces distributed along its exterior surface.

17. The border component according to claim 16, wherein said cushioning exterior layer is constructed of shredded rubber bonded with elastic adhesive urethane to form a porous compound.

18. The border component according to claim 17, wherein said drain pipe has a male fitting at a first end of said drain pipe and a female fitting at second end of said drain pipe.

19. The border component according to claim 18, wherein said drain pipe is constructed of PVC plastic.

20. The border component according to claim 19, wherein said annular spaces are circular in shape.

21. The border component according to claim 20, wherein said annular spaces are approximately three (3) inches apart.

22. The border component according to claim 21, wherein said anchor strap is secured to said drain pipe with a riveted strap.

23. The border component according to claim 22, wherein said riveted strap extends from and parallel to the lower face of the cushioning exterior layer where extended end of said riveted strap has an annular space for fitting an anchor pin.
